(19) United States
(12) Patent Application Publication
(10) Pub. No.: US 2025/0288909 A1
(43) Pub. Date: Sep. 18, 2025

(54) METHOD FOR CONTROLLING VIRTUAL OBJECT, AND DEVICE AND STORAGE MEDIUM

(71) Applicant: Beijing Zitiao Network Technology Co., Ltd., Beijing (CN)

(72) Inventors: Xiao PENG, Beijing (CN); Jing GAO, Beijing (CN); Linfei LI, Beijing (CN); Longji FANG, Beijing (CN)

(21) Appl. No.: 18/861,158

(22) PCT Filed: Apr. 25, 2023
(86) PCT No.: PCT/CN2023/090619

§ 371 Date: Oct. 28, 2024

(30) Foreign Application Priority Data
Apr. 28, 2022 (CN) 202210470791.9

(51) Int. Cl. A63F 13/56

(52) U.S. Cl. CPC A63F 13/56

(57) ABSTRACT

A method and apparatus for controlling a virtual object, and a device and a storage medium are provided. The method includes: obtaining posture information of a user in a current frame; in response to determining that the posture information matches a preset posture, controlling movement of a first virtual object and a second virtual object in a current virtual scene based on the posture information; during the movement, in response to determining that the first virtual object and the second virtual object meet a set contact condition, generating a first result; and in response to determining that the first virtual object and the second virtual object do not meet the set contact condition, generating a second result.

This application claims priority to the Chinese patent application No. 202210470791.9, which was filed to the China Patent Office on Apr. 28, 2022. The entire content of this application is incorporated into this application by reference.

### TECHNICAL FIELD

The embodiments of the disclosure relate to the field of virtual reality technology, and in particular, to a method and an apparatus for controlling a virtual object, a device and a storage medium.

### BACKGROUND

Smart terminals (such as smartphones and smart tablets) have become indispensable tools in people's lives. Users can engage in a range of entertainment activities via smart terminals, such as watching short videos and playing games. Currently, when users play games through smart terminals, most of the control is achieved by touching the screen, which offers low convenience and poor interest.

### SUMMARY

The embodiments of the disclosure provides a method and an apparatus for controlling a virtual object, a device and a storage medium. By utilizing posture information of the user, virtual objects can be controlled without the need for the user to touch the screen, thereby enhancing the convenience of controlling virtual objects on the display and increasing the interest.

For the first aspect, an embodiment of the disclosure provides a method for controlling a virtual object, comprising:
acquiring posture information of a user in a current frame;
controlling movement of a first virtual object and a second virtual object in a current virtual scene based on the posture information in response to determining that the posture information matches a preset posture;
during the movement, generating a first result in response to determining that the first virtual object and the second virtual object meet a set contact condition; generating a second result in response to determining that the first virtual object and the second virtual object do not meet the set contact condition.

For the second aspect, the embodiment of the disclosure further provides a device for controlling a virtual object, comprising:
a posture information acquisition module configured to acquire posture information of a user in a current frame;
a motion control module configured to control movement of a first virtual object and a second virtual object in a current virtual scene based on the posture information if it matches a preset posture;
a result generation module configured to generate a first result during movement if the first virtual object and the second virtual object meet a set contact condition; generate a second result if the first virtual object and the second virtual object do not meet the set contact condition.

For the third aspect, the embodiment of the disclosure further provides an electronic device, comprising:
at least one processor;
a storage device configured to store at least one program,
wherein when the at least one program is executed by the at least one processor, the processor implements the method for controlling the virtual object as described in the embodiment of the disclosure.

For the fourth aspect, an embodiment of the disclosure further provides a computer-readable storage medium containing a computer program, wherein the computer program, when executed by a computer processor, is configured to perform the method for controlling the virtual object as described in the embodiments of the disclosure.

### BRIEF DESCRIPTION OF DRAWINGS

FIG. 1 is a schematic flowchart of a method for controlling a virtual object provided by an embodiment of the disclosure;

FIG. 2 is an example diagram of the movement of a first virtual object and a second virtual object provided by an embodiment of the disclosure;

FIG. 3 is an example diagram of a progress bar provided by an embodiment of the disclosure;

FIG. 4 is an example diagram of determining that the first virtual object and the second virtual object meet the set contact conditions provided by an embodiment of the disclosure;

FIG. 5 is a schematic diagram of the current scene interface provided by an embodiment of the disclosure;

FIG. 6 is a schematic structural diagram of a device for controlling a virtual object provided by an embodiment of the disclosure;

FIG. 7 is a schematic structural diagram of an electronic device provided by an embodiment of the disclosure.

### DETAILED DESCRIPTION

The terms “comprising” and its variations, as used herein, are open-ended and mean “including but not limited to.” The term “based on” means “at least partially based on.” The term “one embodiment” means “at least one embodiment”; the term “another embodiment” means “at least one additional embodiment”; and the term “some embodiments” means “at least some embodiments.” Relevant definitions of other terms will be provided in the descriptions below.

It should be noted that the concepts of “first,” “second,” etc., mentioned in this disclosure are used only to distinguish between different devices, modules, or units and are not intended to limit the sequence or interdependency of the functions performed by these devices, modules, or units.

It should be noted that the modifiers “a” and “a plurality of” in this disclosure are indicative rather than restrictive. Those skilled in the art should understand that, unless explicitly stated otherwise in context, these should be interpreted as “at least one.”

The names of messages or information exchanged between a plurality of devices in the embodiments of this disclosure are merely for illustrative purposes and are not intended to limit the scope of these messages or information.

It is understood that before using the technical solutions disclosed in this embodiment, the types, scope, and usage scenarios of personal information involved in this disclosure should be communicated to users and their authorization should be obtained appropriately in accordance with relevant laws and regulations.

For example, when responding to a user's active request, a prompt message should be sent to the user to clearly indicate that the operation requested by the user will require the acquisition and use of their personal information. This allows the user to independently decide whether to provide personal information to the software or hardware executing the technical solutions of this disclosure, such as electronic devices, applications, servers, or storage media.

As an optional but non-limiting implementation, in response to receiving a user's active request, the method of sending a prompt message to the user can be a pop-up window, which can display the prompt message in text form. Additionally, the pop-up window can contain selection controls for the user to agree or disagree to provide personal information to the electronic device.

It is understood that the above notification and authorization process for users is illustrative and does not limit the implementation of this disclosure. Other methods that comply with relevant laws and regulations can also be applied to the implementations of this disclosure.

It is understood that the data involved in this technical solution (including but not limited to the data itself, the acquisition, or use of the data) should comply with the requirements of applicable laws and regulations.

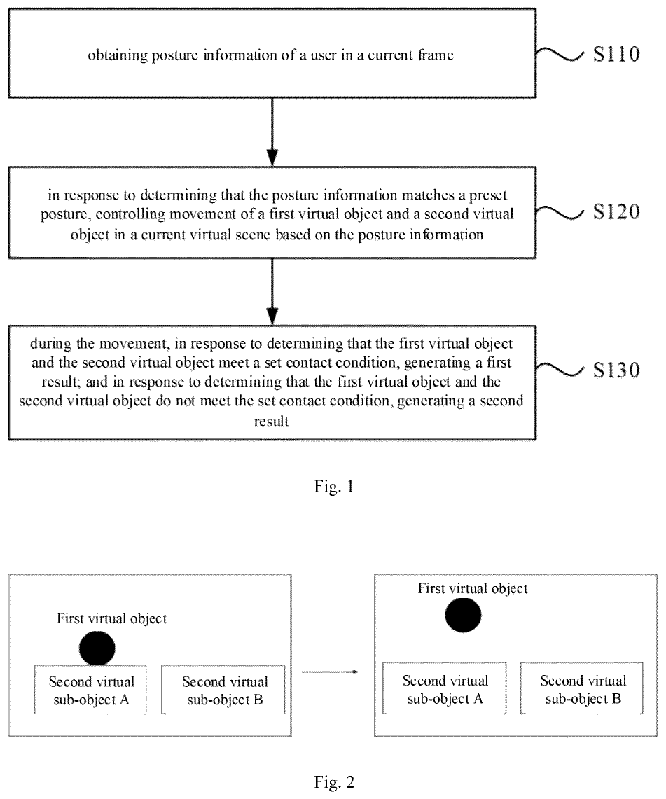

FIG. 1 is a schematic flowchart of a method for controlling a virtual object provided by an embodiment of the disclosure. This embodiment applies to controlling a virtual object in a virtual scene based on posture information. The method can be executed by a device for controlling the virtual object, which can be implemented in software, hardware, or a combination of both. Optionally, it can be implemented through an electronic device, such as a mobile terminal, personal computer (PC), or server.

As shown in FIG. 1, the method includes:
S110: Obtain the user's posture information in the current frame.

In this embodiment, the user stands in front of the camera and assumes a corresponding posture according to the prompt information. The terminal captures the user's image in the current frame, analyzes the image, and obtains the user's posture information in the current frame.

The prompt information can be presented in text, image, or a combination of text and image, and displayed on the current interface for the user to refer to. The image can be a static image, a dynamic image (e.g., a Graphics Interchange Format (GIF) image), or a video. The image is set to guide the user to assume the corresponding posture.

Optionally, before obtaining the user's posture information in the current frame, the method further includes: obtaining image information corresponding to a preset posture; rendering the image information to the current interface for display, allowing the user to assume the corresponding posture according to the image.

The image information can be a static image, a dynamic image, or a video. The preset posture can be any posture set by the technician or chosen by the user. Examples include: a squatting posture, a posture with both arms raised above the head forming a heart shape, an archery posture, a waving posture, etc., which are not limited here. In the application scenario of this instance, when the user is detected to have entered the game, the game application calls the image information corresponding to the preset posture, decodes and renders the image, and displays the rendered image information on the current interface, allowing the user to assume the corresponding posture according to the image. To prevent the standard image from affecting the frame of the subsequent virtual scene, if the image is a static image, it is removed from the current interface or the window displaying the static image is closed after displaying for a set duration (e.g., 3 seconds). If the image is a dynamic image or a video, it is removed from the current interface or the window displaying the dynamic image is closed after the dynamic image or video has finished playing. In this embodiment, displaying the preset posture in the form of an image can guide the user to quickly enter the game, thereby improving the user experience.

In the application scenario of this embodiment, the preset posture can remain unchanged, change once every set duration, or change when the virtual scene reaches a set node (e.g., entering a new game level). Changing the preset posture according to a certain rule can increase the level of interest.

In this embodiment, obtaining the user's posture information in the current frame can be understood as obtaining the user's posture category to determine whether the user's posture information matches the preset posture. For example, the method of obtaining the user's posture information in the current frame can be: obtaining the positional information of multiple set skeletal points of the user in the current frame; determining the user's posture information in the current frame based on the positional information of multiple set skeletal points; or inputting the user's image into a classification model to obtain the posture information.

The set skeletal points can be determined by the preset posture, meaning that different preset postures correspond to different skeletal points. The recognition of skeletal point positions can use any related posture recognition technology, and this is not limited here. For example, assuming the preset posture is “squatting,” the set skeletal points can include: chest skeletal point, hip skeletal point, knee skeletal point, and ankle skeletal point. If the preset posture is “waving,” the set skeletal points can include: upper arm skeletal point, elbow skeletal point, and wrist skeletal point.

For example, after obtaining the positional information of multiple set skeletal points, the user's posture information can be determined based on the angles formed by multiple set skeletal points or the distance ratios of multiple set skeletal points.

Optionally, if the preset posture is squatting, the method for determining whether the posture information matches the preset posture can be at least one of the following: determining whether the posture information matches the preset posture based on the angle formed by the hip skeletal point, knee skeletal point, and ankle skeletal point; determining whether the posture information matches the preset posture based on the distance ratio of the skeletal points.

The distance ratio of the skeletal points is: the ratio of the sum of the distance between the ankle skeletal point and the knee skeletal point and the distance between the knee skeletal point and the hip skeletal point to the distance between the hip skeletal point and the chest skeletal point. The formula can be expressed as: distance ratio of the skeletal points=((distance between ankle and knee)+(distance between knee and hip))/(distance from hip to chest).

For example, if the angle formed by the line connecting the hip skeletal point and the knee skeletal point and the line connecting the knee skeletal point and the ankle skeletal point is less than a set value (e.g., set to 150 degrees), it indicates that the user is currently in a “squatting” posture, matching the preset posture. In this application scenario, if the user is detected to be side-facing the camera, the posture information can be determined to match the preset posture based on the angle formed by the hip skeletal point, knee skeletal point, and ankle skeletal point. For example, if the distance ratio of the skeletal points is less than a set value (e.g., set to 0.7), it indicates that the user is currently in a “squatting” posture, matching the preset posture. In this application scenario, if the user is detected to be facing or back-facing the camera, the posture information can be determined to match the preset posture based on the distance ratio of the skeletal points. In this embodiment, determining the user's posture information category based on the angle formed by the set skeletal points or the distance ratio can improve the efficiency of posture information recognition.

The classification model can be a neural network model trained with a large number of posture image samples. By inputting the current human body image into the classification model, the user's current posture information can be obtained. In this embodiment, determining the posture information category through the classification model can improve recognition accuracy.

S120, in response to determining that the posture information matches the preset posture, control the movement of the first virtual object and the second virtual object in the current virtual scene based on the posture information.

The first virtual object can be a virtual character, a virtual ball, etc., and this is not limited here. The category of the second virtual object can be the same as or different from the first virtual object. In this application scenario, the second virtual object can be set to carry the first virtual object, such as a virtual platform.

In this embodiment, the principle of controlling the movement of the first virtual object and the second virtual object in the current virtual scene based on the posture information can be: determining a control force based on the posture information, and controlling the movement of the first virtual object and the second virtual object based on this control force.

For example, when the user's current posture information matches the preset posture, the method of controlling the movement of the first virtual object and the second virtual object in the current virtual scene based on the posture information can be: determining a first duration for which the user remains in the posture corresponding to the posture information; determining the control force based on the first duration; controlling the movement of the first virtual object and the second virtual object in the current virtual scene based on the control force.

The magnitude of the control force is positively correlated with the first duration, and this positive correlation can be linear or gradient. Linear positive correlation means that the magnitude of the control force increases linearly with the first duration, where different control force values correspond to different first duration values. Gradient positive correlation means that the magnitude of the control force increases in steps with the first duration, where a control force value corresponds to a segment of duration. In this embodiment, a threshold can be set for the control force, and it will not increase further once this threshold is exceeded.

In this embodiment, the methods for controlling the movement of the first virtual object and the second virtual object based on the control force can include at least one of the following: controlling the first virtual object and the second virtual object to move in different directions; controlling the first virtual object and the second virtual object to move in different ways. For example, controlling the first virtual object to move upward in a parabolic motion, and controlling the second virtual object to move uniformly in the horizontal direction.

Optionally, the method of controlling the movement of the first virtual object and the second virtual object in the current virtual scene based on the control force can include: determining the first component and the second component of the control force; controlling the movement of the first virtual object based on the first component, and controlling the movement of the second virtual object based on the second component.

The direction of the control force can be preset, and its magnitude is determined by the first duration. The first component can be the vertical component, and the second component can be the horizontal component. In this embodiment, the method of determining the first component and the second component of the control force can include: decomposing the control force into forces in the horizontal and vertical directions to obtain the first component and the second component.

For example, if the first component is the vertical component, the method of controlling the movement of the first virtual object based on the first component can be: using the principle of parabolic motion to control the first virtual object to execute parabolic motion. If the second component is the horizontal component, the method of controlling the movement of the second virtual object based on the second component can be: controlling the second virtual object to move uniformly in the horizontal direction. For example, FIG. 2 shows an instance of the movement of the first virtual object and the second virtual object in this embodiment. As shown in FIG. 2, the left figure shows the state before the movement, where the first virtual object is on the second virtual sub-object A. The right figure shows the state during the movement, where the first virtual object moves upward driven by the first component, and the second virtual sub-objects A and B move uniformly to the left driven by the second component. In this embodiment, the two components of the decomposed control force can accurately control the movement of the first virtual object and the second virtual object.

Optionally, the method of controlling the movement of the first virtual object and the second virtual object in the current virtual scene based on the posture information can include: controlling the movement of the first virtual object and the second virtual object in the current virtual scene in response to meeting any of the following trigger conditions: the first duration exceeds a first set threshold; the control force reaches a second set threshold; or detecting a change in the posture information in the frame that matches the preset posture.

In this embodiment, the movement of the first virtual object and the second virtual object is controlled only when the trigger conditions are met. The trigger conditions include: the user remains in the posture information that matches the preset posture for a first duration that exceeds the first set threshold, or the control force reaches the second set threshold, or a change is detected in the posture information in the frame that matches the preset posture.

The first set threshold can be set to any value between 5 and 10 seconds, and the second set threshold is determined by the technician based on the actual game situation. Detecting a change in the posture information in the current frame that matches the preset posture can be understood as: the user changes from the preset posture to another posture. For example, if the preset posture is “squatting,” and the user is detected to change from “squatting” to “standing,” then the trigger condition is met. In this embodiment, controlling the movement of the first virtual object and the second virtual object only when the trigger conditions are met can improve the user experience.

Optionally, the method for controlling the virtual object further includes: setting a progress bar on the interface of the current virtual scene; controlling the progress of the progress bar based on the first duration; determining a target color based on the progress and controlling the progress bar to display the target color.

The progress bar can be set to display the growth progress of the control force. In this embodiment, as the control force increases with the first duration, the progress of the progress bar also increases with the first duration. Different colors can be used to represent different levels of progress. Suppose the control force is divided into three levels: low, medium, and high. In that case, the progress bar can use different colors to correspond to these levels, such as yellow, orange, and red for low, medium, and high levels, respectively. Optionally, after the movement of the first virtual object and the second virtual object, the progress of the progress bar returns to the original state.

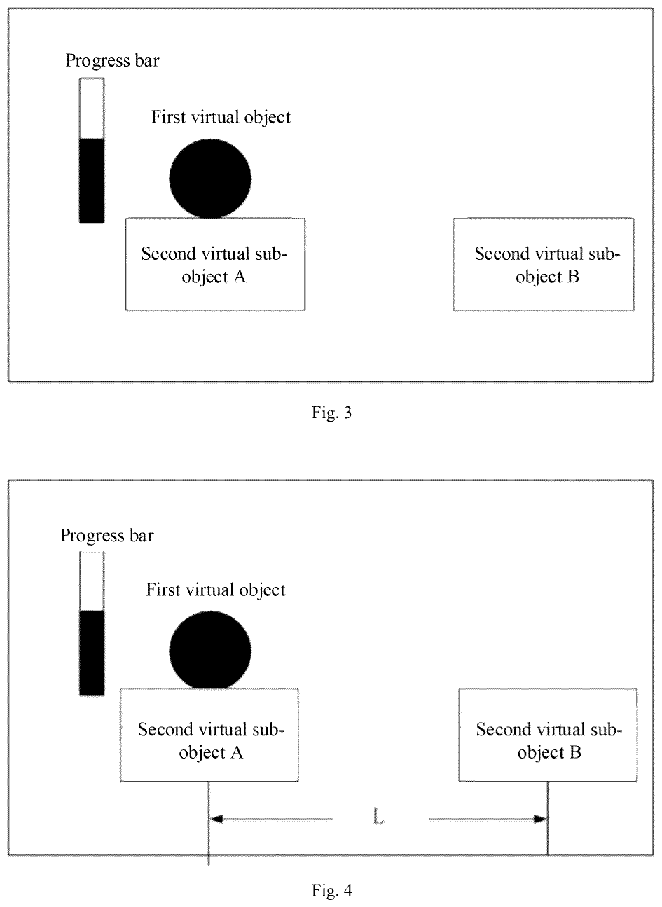

An exemplary illustration is shown in FIG. 3, which depicts a progress bar in this embodiment. As illustrated in FIG. 3, the height of the progress bar indicates progress, indirectly reflecting the magnitude of the control force. This allows users to intuitively see the size of the control force, enhancing the interface's diversity and aiding users in accurately controlling the virtual object, thereby increasing the fun.

Optionally, before controlling the movement of the first virtual object and the second virtual object in the current virtual scene based on posture information, the method further includes: obtaining animation data of the first virtual object corresponding to the preset posture; playing the animation data of the first virtual object so that the first virtual object displays the preset posture.

For instance, when the user's posture information is detected to match the preset posture, the game application (APP) obtains the animation data of the first virtual object corresponding to the preset posture and plays the animation data at the position of the original first virtual object, causing the first virtual object to also display the preset posture. For example, if the preset posture is “squatting,” the system obtains the animation data of the first virtual object squatting and plays it, making the first virtual object also adopt a squatting posture. In this embodiment, playing the animation data of the first virtual object to display the same posture as the user can enhance the fun.

S130, during the movement process, in response to determining that the first virtual object and the second virtual object meet the set contact conditions, a first result is generated; in response to determining that the first virtual object and the second virtual object do not meet the set contact conditions, a second result is generated.

The set contact conditions can include the first virtual object colliding with the second virtual object, or the first virtual object landing on top of the second virtual object. These conditions can be set according to game requirements and are not limited here. The first result can be a successful challenge, and the second result can be a failed challenge.

Optionally, the second virtual object includes multiple second virtual sub-objects, which are arranged at intervals. The distances between adjacent second virtual sub-objects can be the same or different. Before movement, the first virtual object is located on one of the second virtual sub-objects.

The second virtual sub-objects can be virtual platforms, and set to carry the first virtual object. The distances between adjacent second virtual sub-objects can include multiple levels, such as close, medium, and far distances. These distance levels can be represented by different colors or shapes to prompt the user to determine the first duration in the preset posture, thereby ensuring that the first virtual object and the second virtual object meet the set contact conditions after movement.

Accordingly, the method for determining that the first virtual object and the second virtual object meet the set contact conditions can be: if the first virtual object lands on the second virtual sub-object, then the set contact conditions are met.

Optionally, the method for determining that the first virtual object and the second virtual object meet the set contact conditions can include: determining the second duration required for the first virtual object to move to the set position based on the first component, and obtaining the first distance between the initial position and the set position of the second virtual object; determining the movement speed of the second virtual object based on the second component; determining the second distance that the second virtual object moves based on the movement speed and the second duration; in response to the first distance being equal to the second distance, determining that the first virtual object and the second virtual object meet the set contact conditions.

The set position can be any position set according to requirements. In this embodiment, if the first component is the vertical component, the set position can be the initial position of the first virtual object. Thus, determining the second duration required for the first virtual object to move to the set position based on the first component can be understood as the duration from when the first virtual object is thrown up to when it falls back to the initial position. This second duration can be determined using the principle of parabolic motion in physics, which will not be elaborated on here.

The method for determining the movement speed of the second virtual object based on the second component can be: pre-establishing a correspondence between force and speed, and using a lookup table to obtain the movement speed corresponding to the second component. This controls the second virtual object to move at a uniform speed according to this movement speed.

In this embodiment, the movement duration of the first virtual object and the second virtual object is the same, so the movement distance of the second virtual object, i.e., the second distance, can be calculated based on the movement speed and the second duration of the second virtual object. If the second distance equals the first distance, the first virtual object and the second virtual object meet the set contact conditions. If the second distance does not equal the first distance, the first virtual object and the second virtual object do not meet the set contact conditions. For example, FIG. 4 illustrates an example of determining that the first virtual object and the second virtual object meet the set contact conditions in this embodiment. As shown in FIG. 4, before the movement, the first virtual object is located on the second virtual sub-object A. Assuming that the duration required for the first virtual object to be thrown up and fall back to the initial position is t, the movement speed of the second virtual sub-objects A and B to the left is v, and the distance between the second virtual sub-object B and the first virtual object is L, if vt=L, the first virtual object will land on the second virtual sub-object B, thus meeting the contact conditions. The technical solution of this embodiment, which determines whether the contact conditions are met based on the movement duration of the first virtual object and the movement distance of the second virtual object, can improve accuracy.

Optionally, after generating the first result, the method further includes: rendering and displaying a new second virtual sub-object.

The distance between the newly rendered second virtual sub-object and the second virtual sub-object where the first virtual object is located can be randomly configured by the game APP, thereby enhancing the game's fun. Rendering and displaying the new second virtual sub-object allows the user to continue challenging tasks.

Optionally, after generating the second result, the method further includes: invoking and playing the animation data corresponding to the second result.

If the second result is a failed challenge, the animation data corresponding to the failed challenge can be played. For instance, if the set condition is that the first virtual object lands on the second virtual object, then the animation data corresponding to the second result can be the first virtual object falling off the second virtual object. In this embodiment, if the challenge fails, invoking and playing the animation data corresponding to the second result can enhance the display effect.

Optionally, the method further includes: setting up a result statistics bar in the interface of the current virtual scene; accumulating the current score based on the first result and updating the current score to the accumulated score.

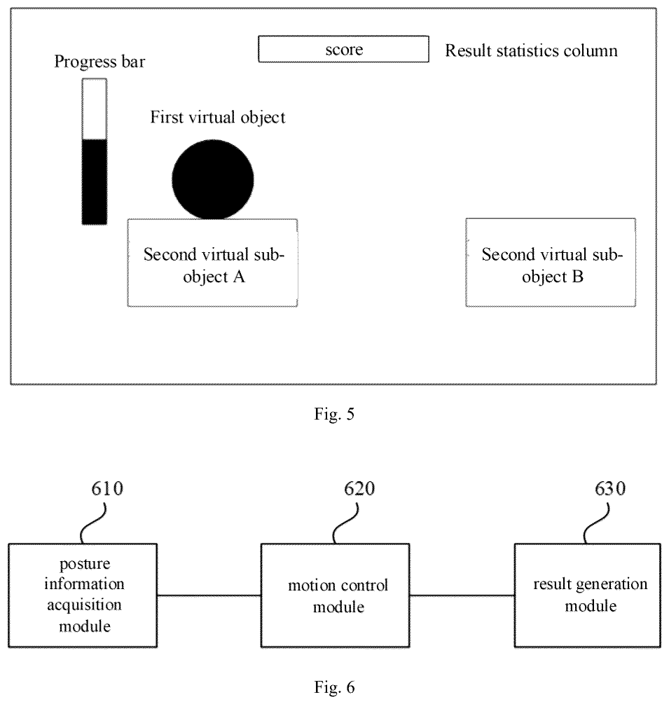

The result statistics column displays the current score. For example, if the challenge is successful, the score is increased by 1. FIG. 5 illustrates the interface of the current scene in this embodiment. As shown in FIG. 5, the result statistics column is set at the top of the interface. In this embodiment, the result statistics column displays the user's challenge results, allowing the user to intuitively see their challenge performance.

Based on the above embodiments, a detailed implementation of the scheme is described below. The interface of the current virtual scene includes a virtual character, multiple virtual platforms, a progress bar, and a result statistics column. There are certain gaps between the multiple virtual platforms. Before the game starts, the virtual character is on one of the virtual platforms. When the user enters the game, the front camera is activated, and an image corresponding to the preset posture (e.g., squatting) is displayed to guide the user to assume the corresponding posture. The user enters the frame of the font camera and squats, when the user's squatting posture is detected, the squatting animation data of the virtual character is invoked and played, and the duration of the user's squatting is recorded. This duration is used to control the progress of the progress bar and to determine the control force based on the squatting duration. When the trigger conditions are met, the virtual character is controlled to move upward based on the determined control force, and the multiple virtual platforms are controlled to move to the left. If the virtual character lands on the next virtual platform, the challenge is successful, a new virtual platform is rendered, and the score in the result statistics column is incremented by 1. If the virtual character does not land on the next virtual platform, the falling animation of the virtual character is played, and the challenge fails.

The technical solution of this embodiment involves obtaining the user's posture information in the current frame; if the posture information matches the preset posture, controlling the movement of the first virtual object and the second virtual object in the current virtual scene based on the posture information; during the movement, if the first virtual object and the second virtual object meet the set contact conditions, generating the first result; if the first virtual object and the second virtual object do not meet the set contact conditions, generating the second result. The virtual object control method provided by this embodiment controls the movement of virtual objects based on posture information, eliminating the need for the user to touch the screen to control, thereby improving the convenience and fun of controlling virtual objects on the frame.

FIG. 6 is a schematic diagram of the structure of a virtual object control device provided by the present disclosure. As shown in FIG. 6, the device includes:
Posture Information Acquisition Module 610 configured to acquire the user's posture information in the current frame;
Motion Control Module 620 configured to, in response to determining that the posture information matches the preset posture, control the movement of the first virtual object and the second virtual object in the current virtual scene based on the posture information;
Result Generation Module 630 configured to, during movement, generate a first result in response to determining that the first virtual object and the second virtual object meet the set contact conditions; and generate a second result in response to determining that the first virtual object and the second virtual object do not meet the set contact conditions.

Optionally, the motion control module 620 is also configured to:
determine the first duration for which the user is in the posture corresponding to the posture information;
determine the control force based on the first duration;
control the movement of the first virtual object and the second virtual object in the current virtual scene based on the control force.

Optionally, the motion control module 620 is also configured to:
determine the first component and the second component of the control force;
control the movement of the first virtual object based on the first component and the movement of the second virtual object based on the second component.

Optionally, the result generation module 630 is also configured to:
determine the second duration required for the first virtual object to move to the set position based on the first component, and acquire the first distance from the initial position of the second virtual object to the set position;
determine the movement speed of the second virtual object based on the second component;
determine the second distance moved by the second virtual object based on the movement speed and the second duration;
determine that the first virtual object and the second virtual object meet the set contact conditions in response to the first distance being equal to the second distance.

Optionally, the motion control module 620 is also configured to:
control the movement of the first virtual object and the second virtual object in the current virtual scene in response to meeting any one of the following trigger conditions:

The first duration exceeds a first set threshold; the control force reaches a second set threshold; or, the posture information in the frame changes from matching the preset posture.

Optionally, the virtual object control device further includes: progress bar setting module configured to:
set a progress bar in the interface of the current virtual scene;
control the progress of the progress bar based on the first duration;
determine the target color based on the progress and control the progress bar to display the target color.

Optionally, the posture information acquisition module 610 is also configured to:
acquire the positional information of multiple set skeletal points of the user in the current frame;
determine the user's posture information in the current frame based on the positional information of the multiple set skeletal points.

Optionally, the preset posture is squatting, and the multiple set skeletal points include chest skeletal point, hip skeletal point, knee skeletal point, and ankle skeletal point.

The posture information acquisition module 610 is also configured to perform at least one of the following:
determine whether the posture information matches the preset posture based on the angle formed by the hip skeletal point, knee skeletal point, and ankle skeletal point;
determine whether the posture information matches the preset posture based on the distance ratio of skeletal points; wherein the distance ratio of skeletal points is the ratio of the sum of the distance between the ankle skeletal point and knee skeletal point and the distance between the knee skeletal point and hip skeletal point to the distance between the hip skeletal point and chest skeletal point.

Optionally, the virtual object control device further includes: preset posture display module configured to:
acquire the image information corresponding to the preset posture, wherein the image information is a static image, dynamic image, or video;
render the image information to the current interface for display, allowing the user to assume the corresponding posture based on the image.

Optionally, the virtual object control device further includes: a first animation playback module configured to:
acquire the first virtual object animation data corresponding to the preset posture;
play the first virtual object animation data to make the first virtual object present the preset posture.

Optionally, the second virtual object includes multiple second virtual sub-objects, arranged at intervals, with the distance between adjacent second virtual sub-objects being the same or different; and before movement, the first virtual object is located on one of the second virtual sub-objects.

The result generation module 630 is further configured to:
determine that the first virtual object and the second virtual object meet the set contact conditions in response to the first virtual object landing on the second virtual sub-object.

Optionally, the virtual object control device further includes: a rendering module configured to:
render and display a new second virtual sub-object.

Optionally, the virtual object control device further includes: a second animation playback module configured to:
invoke and play the animation data corresponding to the second result.

Optionally, the virtual object control device further includes: a result statistics column setting module configured to:
set a result statistics column in the interface of the current virtual scene, wherein the result statistics column displays the current score;
accumulate the current score based on the first result and update the current score to the accumulated score.

The virtual object control device provided by the embodiments of the present disclosure can execute the virtual object control method provided by any embodiment of the present disclosure, and includes corresponding functional modules and effects for executing the method.

It should be noted that the units and modules included in the above device are divided according to functional logic, but are not limited to the above division as long as the corresponding functions can be realized; in addition, the names of the functional units are only for mutual distinction and do not limit the protection scope of the embodiments of the present disclosure.

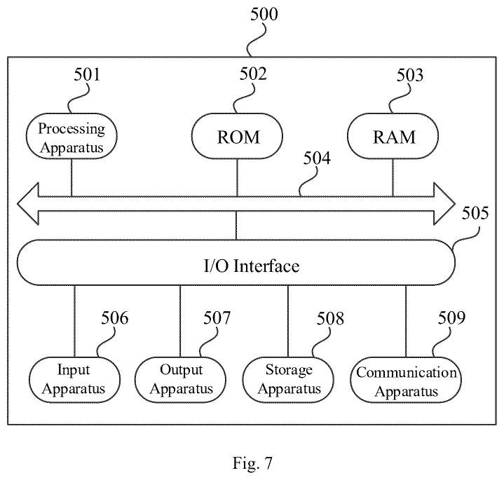

FIG. 7 is a schematic diagram of the structure of an electronic device provided by an embodiment of the present disclosure. Referring to FIG. 7, the electronic device 500 suitable for implementing the embodiments of the present disclosure (such as the terminal device or server shown in FIG. 7) is illustrated. The terminal device in this embodiment can include, but is not limited to, mobile terminals such as mobile phones, laptops, digital broadcast receivers, personal digital assistants (PDAs), tablets (PADs), portable media players (PMPs), in-car terminals (such as in-car navigation terminals), and fixed terminals such as digital TVs and desktop computers. The electronic device shown in FIG. 7 is merely an example and should not impose any limitations on the functions and scope of use of the embodiments of the present disclosure.

As shown in FIG. 7, the electronic device 500 may include a processor (e.g., a central processing unit, a graphics processing unit, etc.) 501. The processor 501 can perform various appropriate actions and processes according to programs stored in a read-only memory (ROM) 502 or programs loaded into a random access memory (RAM) 503 from a storage device 508. Various programs and data required for the operation of the electronic device 500 are also stored in the RAM 503. The processor 501, ROM 502, and RAM 503 are interconnected via a bus 504. An input/output (I/O) interface 505 is also connected to the bus 504.

Typically, the following devices can be connected to the I/O interface 505: input devices 506 including, for example, a touchscreen, touchpad, keyboard, mouse, camera, microphone, accelerometer, and gyroscope; output devices 507 including, for example, a liquid crystal display (LCD), speaker, and vibrator; storage devices 508 including, for example, magnetic tapes and hard disks; and communication devices 509. The communication device 509 allows the electronic device 500 to communicate wirelessly or via wired connections with other devices to exchange data. Although FIG. 7 shows the electronic device 500 with various devices, it should be understood that it is not required to implement or include all the devices shown. More or fewer devices can be implemented or included instead.

Specifically, according to an embodiment of the present disclosure, the processes described above with reference to the flowcharts can be implemented as a computer software program. For example, an embodiment of the present disclosure includes a computer program product, which includes a computer program carried on a non-transitory computer storage medium. The computer program contains program code for performing the method shown in the flowcharts. In such an embodiment, the computer program can be downloaded and installed from a network via the communication device 509, installed from the storage device 508, or installed from the ROM 502. When the computer program is executed by the processor 501, it performs the functions defined in the methods of the embodiments of the present disclosure.

The electronic device provided by the present disclosure and the virtual object control method provided by the above embodiments belong to the same inventive concept. Technical details not exhaustively described in this embodiment can be referred to in the above embodiments, and this embodiment has the same effects as the above embodiments.

The present disclosure provides a computer-readable storage medium storing a computer program, which, when executed by a processor, implements the virtual object control method provided in the above embodiments.

It should be noted that the computer-readable storage medium described above can be a computer-readable signal medium or a computer-readable storage medium, or any combination of the two. A computer-readable storage medium can be, but is not limited to, an electrical, magnetic, optical, electromagnetic, infrared, or semiconductor system, apparatus, or device, or any suitable combination of these. Examples of computer-readable storage media include, but are not limited to: electrical connections having at least one wire, portable computer disks, hard drives, random access memory (RAM), read-only memory (ROM), erasable programmable read-only memory (EPROM), flash memory, optical fibers, portable compact disc read-only memory (CD-ROM), optical storage devices, magnetic storage devices, or any suitable combination of the above. In this disclosure, a computer-readable storage medium can be any tangible medium that contains or stores programs that can be used or executed by an instruction execution system, apparatus, or device, or in combination with them. In this disclosure, a computer-readable signal medium can include propagated data signals with computer-readable program codes embodied therein, either in baseband or as part of a carrier wave. Such propagated data signals can take many forms, including but not limited to, electromagnetic signals, optical signals, or any suitable combination of these. A computer-readable signal medium can be any computer-readable medium other than a computer-readable storage medium that can transmit, propagate, or transport a program for use by or in combination with an instruction execution system, apparatus, or device. The program code embodied on the computer-readable storage medium can be transmitted using any suitable medium, including but not limited to, wired, optical fiber, radio frequency (RF), etc., or any suitable combination of these.

In some embodiments, clients and servers can communicate using any current or future-developed network protocol, such as HyperText Transfer Protocol (HTTP), and can be interconnected by any form or medium of digital data communication (e.g., a communication network). Examples of communication networks include local area networks (LANs), wide area networks (WANs), the internet, and point-to-point networks (e.g., ad hoc networks), and any current or future-developed network.

The computer-readable storage medium described above can be included in the aforementioned electronic device or can be separately provided without being incorporated into the electronic device.

The computer-readable storage medium carries at least one program, and when the at least one program is executed by the electronic device, it enables the electronic device to: obtain the user's posture information in the current frame; if the posture information matches a preset posture, control the movement of the first virtual object and the second virtual object in the current virtual scene based on the posture information; during the movement, if the first virtual object and the second virtual object meet the preset contact condition, generate a first result; if the first virtual object and the second virtual object do not meet the preset contact condition, generate a second result.

The computer program code for performing the operations of the present disclosure can be written in any suitable programming language or combination of programming languages, including but not limited to, object-oriented programming languages such as Java, Smalltalk, C++, and conventional procedural programming languages such as “C” language or similar programming languages. The program code can be executed entirely on the user's computer, partly on the user's computer, as a stand-alone software package, partly on the user's computer and partly on a remote computer, or entirely on a remote computer or server. In the case of remote computers, they can be connected to the user's computer via any kind of network—local area network (LAN) or wide area network (WAN), or they can be connected to external computers (e.g., via the internet using an internet service provider).

The flowcharts and block diagrams in the accompanying drawings illustrate possible system architectures, functionalities, and operations for implementing various embodiments of the present disclosure. In this respect, each block in the flowcharts or block diagrams can represent a module, program segment, or portion of code that includes one or more executable instructions for implementing the specified logical function(s). It should also be noted that, in some alternative implementations, the functions noted in the blocks may occur in a different order than depicted in the drawings. For example, two blocks shown in succession may in fact be executed substantially concurrently, or the blocks may sometimes be executed in the reverse order, depending on the functionality involved. It should also be noted that each block in the block diagrams and flowcharts, and combinations of blocks, can be implemented by a special-purpose hardware-based system that performs the specified functions or operations, or by a combination of special-purpose hardware and computer instructions.

The units involved in the embodiments of the present disclosure can be implemented in software, hardware, or a combination of both. The names of the units are not meant to limit the units themselves; for example, the “first acquisition unit” can also be described as “a unit for acquiring at least two internet protocol addresses.”

The functions described above can be performed, at least in part, by at least one hardware logic component. For example, and without limitation, exemplary types of hardware logic components that can be used include: field-programmable gate arrays (FPGAs), application-specific integrated circuits (ASICs), application-specific standard products (ASSPs), system-on-chip (SOC), complex programmable logic devices (CPLDs), etc.

In the context of this disclosure, a machine-readable storage medium can be a tangible medium that can contain or store programs for use by or in combination with an instruction execution system, apparatus, or device. A machine-readable storage medium can be a machine-readable signal medium or a machine-readable storage medium. A machine-readable storage medium can include, but is not limited to, electronic, magnetic, optical, electromagnetic, infrared, or semiconductor systems, devices, or apparatuses, or any suitable combination of these. Examples of machine-readable storage media include, but are not limited to, electrical connections having one or more wires, portable computer disks, hard drives, random access memory (RAM), read-only memory (ROM), erasable programmable read-only memory (EPROM), flash memory, optical fibers, portable compact disc read-only memory (CD-ROM), optical storage devices, magnetic storage devices, or any suitable combination of the above.

At least one embodiment of the disclosure provides a method for controlling a virtual object, comprising:
obtaining posture information of a user in a current frame;
in response to determining that the posture information matches a preset posture, controlling movement of a first virtual object and a second virtual object in a current virtual scene based on the posture information;
during the movement, in response to determining that the first virtual object and the second virtual object meet a set contact condition, generating a first result; and in response to determining that the first virtual object and the second virtual object do not meet the set contact condition, generating a second result.

For example, controlling the movement of the first virtual object and the second virtual object in the current virtual scene based on the posture information comprises:
determining a first duration in which the user is in a posture corresponding to the posture information;
determining a control force based on the first duration; and
controlling the movement of the first virtual object and the second virtual object in the current virtual scene based on the control force.

For example, controlling the movement of the first virtual object and the second virtual object in the current virtual scene based on the control force comprises:
determining a first component and a second component of the control force;
controlling the movement of the first virtual object based on the first component, and controlling the movement of the second virtual object based on the second component.

For example, determining that the first virtual object and the second virtual object meet the set contact condition comprises:
determining a second duration required for the first virtual object to move to a set position based on the first component, and obtaining a first distance between an initial position of the second virtual object and the set position;
determining a movement velocity of the second virtual object based on the second component;
determining a second distance that the second virtual object moves based on the movement velocity and the second duration; and
in response to the first distance being equal to the second distance, determining that the first virtual object and the second virtual object meet the set contact condition.

For example, controlling the movement of the first virtual object and the second virtual object in the current virtual scene based on the posture information comprises:
in response to satisfying any one of the following triggering conditions, controlling the movement of the first virtual object and the second virtual object in the current virtual scene:
the first duration exceeds a first set threshold; the control force reaches a second set threshold; or, a change is detected in posture information matching the preset posture in the frame.

For example, the method further comprises:
setting a progress bar in an interface of the current virtual scene;
controlling progress of the progress bar based on the first duration; and
determining a target color based on the progress and controlling display of the progress bar to show the target color.

For example, obtaining the posture information of the user in a current frame comprises:
obtaining position information of multiple predetermined skeletal points of the user in the current frame; and
determining the posture information of the user in the current frame based on the position information of the multiple predetermined skeletal points.

For example, the preset posture is a squatting posture, and the multiple predetermined skeletal points include a chest skeletal point, a hip skeletal point, a knee skeletal point, and an ankle skeletal point;
determining that the posture information matches the preset posture comprises at least one of the following:
determining whether the posture information matches the preset posture based on an angle formed by the hip skeletal point, the knee skeletal point, and the ankle skeletal point;
determining whether the posture information matches the preset posture based on a distance ratio of skeletal points, where the distance ratio is a ratio of a sum of a distance between the ankle skeletal point and the knee skeletal point and a distance between the knee skeletal point and the hip skeletal point to a distance between the hip skeletal point and the chest skeletal point.

For example, before obtaining the posture information of the user in the current frame, the method further comprises:
obtaining image information corresponding to the preset posture; where the image information is a static image, dynamic image, or video;
rendering the image information on a current interface for display, enabling the user to assume the posture according to the image.

For example, before controlling the movement of the first virtual object and the second virtual object in the current virtual scene based on the posture information, the method further comprises:
obtaining animation data of the first virtual object corresponding to the preset posture;
playing the animation data of the first virtual object to allow the first virtual object to exhibit the preset posture.

For example, the second virtual object comprises multiple second virtual sub-objects arranged at intervals, distances between two adjacent second virtual sub-objects are equal or different, and the first virtual object is located on one of the second virtual sub-objects before movement;
determining that the first virtual object and the second virtual object meet the set contact condition comprises:
in response to the first virtual object landing on another second virtual sub-object, determining that the first virtual object and the second virtual object meet the set contact condition.

For example, after generating the first result, the method further comprises:
rendering and displaying a new second virtual sub-object;
after generating the second result, the method further comprises:
invoking animation data corresponding to the second result to be displayed.

For example, the method further comprises:
setting a result statistics column in an interface of the current virtual scene, wherein a current score is displayed in the result statistics column; and
accumulating the current score based on the first result, and updating the current score to the accumulated score.

Additionally, although multiple operations are depicted in a specific order, this should not be understood as requiring these operations to be executed in the particular order shown or in sequential order. In certain contexts, multitasking and parallel processing may be advantageous. Similarly, although multiple implementation details are included in the above discussion, these should not be construed as limitations on the scope of the present disclosure. Features described in the context of separate embodiments can also be implemented in combination in a single embodiment. Conversely, various features described in the context of a single embodiment can also be implemented separately or in any suitable sub-combination in multiple embodiments.

1. A method for controlling a virtual object, comprising:
obtaining posture information of a user in a current frame;
in response to determining that the posture information matches a preset posture, controlling movement of a first virtual object and a second virtual object in a current virtual scene based on the posture information;
during the movement, in response to determining that the first virtual object and the second virtual object meet a set contact condition, generating a first result; and in response to determining that the first virtual object and the second virtual object do not meet the set contact condition, generating a second result.

2. The method according to claim 1, wherein controlling the movement of the first virtual object and the second virtual object in the current virtual scene based on the posture information comprises:
determining a first duration in which the user is in a posture corresponding to the posture information;
determining a control force based on the first duration; and
controlling the movement of the first virtual object and the second virtual object in the current virtual scene based on the control force.

3. The method according to claim 2, wherein controlling the movement of the first virtual object and the second virtual object in the current virtual scene based on the control force comprises:
determining a first component and a second component of the control force;
controlling the movement of the first virtual object based on the first component, and controlling the movement of the second virtual object based on the second component.

4. The method according to claim 3, wherein determining that the first virtual object and the second virtual object meet the set contact condition comprises:
determining a second duration required for the first virtual object to move to a set position based on the first component, and obtaining a first distance between an initial position of the second virtual object and the set position;
determining a movement velocity of the second virtual object based on the second component;
determining a second distance that the second virtual object moves based on the movement velocity and the second duration; and
in response to the first distance being equal to the second distance, determining that the first virtual object and the second virtual object meet the set contact condition.

5. The method according to claim 2, wherein controlling the movement of the first virtual object and the second virtual object in the current virtual scene based on the posture information comprises:
in response to satisfying any one of the following triggering conditions, controlling the movement of the first virtual object and the second virtual object in the current virtual scene:
the first duration exceeds a first set threshold; the control force reaches a second set threshold; or, a change is detected in posture information matching the preset posture in the frame.

6. The method according to claim 2, further comprising:
setting a progress bar in an interface of the current virtual scene;
controlling progress of the progress bar based on the first duration; and
determining a target color based on the progress and controlling display of the progress bar to show the target color.

7. The method according to claim 1, wherein obtaining the posture information of the user in a current frame comprises:
obtaining position information of multiple predetermined skeletal points of the user in the current frame; and
determining the posture information of the user in the current frame based on the position information of the multiple predetermined skeletal points.

8. The method according to claim 7, wherein the preset posture is a squatting posture, and the multiple predetermined skeletal points include a chest skeletal point, a hip skeletal point, a knee skeletal point, and an ankle skeletal point;
determining that the posture information matches the preset posture comprises at least one of the following:
determining whether the posture information matches the preset posture based on an angle formed by the hip skeletal point, the knee skeletal point, and the ankle skeletal point;
determining whether the posture information matches the preset posture based on a distance ratio of skeletal points, where the distance ratio is a ratio of a sum of a distance between the ankle skeletal point and the knee skeletal point and a distance between the knee skeletal point and the hip skeletal point to a distance between the hip skeletal point and the chest skeletal point.

9. The method according to claim 1, wherein, before obtaining the posture information of the user in the current frame, the method further comprises:
obtaining image information corresponding to the preset posture; where the image information is a static image, dynamic image, or video;
rendering the image information on a current interface for display, enabling the user to assume the posture according to the image.

10. The method according to claim 1, wherein, before controlling the movement of the first virtual object and the second virtual object in the current virtual scene based on the posture information, the method further comprises:
obtaining animation data of the first virtual object corresponding to the preset posture;
playing the animation data of the first virtual object to allow the first virtual object to exhibit the preset posture.

11. The method according to claim 1, wherein the second virtual object comprises multiple second virtual sub-objects arranged at intervals, distances between two adjacent second virtual sub-objects are equal or different, and the first virtual object is located on one of the second virtual sub-objects before movement;
determining that the first virtual object and the second virtual object meet the set contact condition comprises:
in response to the first virtual object landing on another second virtual sub-object, determining that the first virtual object and the second virtual object meet the set contact condition.

12. The method according to claim 11, wherein, after generating the first result, the method further comprises:
rendering and displaying a new second virtual sub-object;
after generating the second result, the method further comprises:
invoking animation data corresponding to the second result to be displayed.

13. The method according to claim 1, further comprising:
setting a result statistics column in an interface of the current virtual scene;
displaying a current score in the result statistics column; and
accumulating the current score based on the first result, and updating the current score to the accumulated score.

14. (canceled)

15. An electronic device, comprising:
at least one processor;
a storage device configured to store at least one program;
wherein when the at least one program is executed by the at least one processor, the at least one processor is caused to:
obtain posture information of a user in a current frame;
in response to determining that the posture information matches a preset posture, control movement of a first virtual object and a second virtual object in a current virtual scene based on the posture information;
during the movement, in response to determining that the first virtual object and the second virtual object meet a set contact condition, generate a first result; and in response to determining that the first virtual object and the second virtual object do not meet the set contact condition, generate a second result.

16. A computer-readable storage medium containing a computer program, wherein the computer program, when executed by a computer processor, performs a method for controlling a virtual object, the method comprises:
obtaining posture information of a user in a current frame;
in response to determining that the posture information matches a preset posture, controlling movement of a first virtual object and a second virtual object in a current virtual scene based on the posture information;
during the movement, in response to determining that the first virtual object and the second virtual object meet a set contact condition, generating a first result; and in response to determining that the first virtual object and the second virtual object do not meet the set contact condition, generating a second result.

17. The electronic device according to claim 15, wherein the at least one processor is further caused to:
determine a first duration in which the user is in a posture corresponding to the posture information;
determine a control force based on the first duration; and
control the movement of the first virtual object and the second virtual object in the current virtual scene based on the control force.

18. The electronic device according to claim 17, wherein the at least one processor is further caused to:
determine a first component and a second component of the control force;
control the movement of the first virtual object based on the first component, and control the movement of the second virtual object based on the second component.

19. The electronic device according to claim 18, wherein the at least one processor is further caused to:
determine a second duration required for the first virtual object to move to a set position based on the first component, and obtain a first distance between an initial position of the second virtual object and the set position;
determine a movement velocity of the second virtual object based on the second component;
determine a second distance that the second virtual object moves based on the movement velocity and the second duration; and
in response to the first distance being equal to the second distance, determine that the first virtual object and the second virtual object meet the set contact condition.

20. The electronic device according to claim 17, wherein the at least one processor is further caused to:
in response to satisfying any one of the following triggering conditions, control the movement of the first virtual object and the second virtual object in the current virtual scene:
the first duration exceeds a first set threshold; the control force reaches a second set threshold; or, a change is detected in posture information matching the preset posture in the frame.
